(19) United States
(12) Patent Application Publication
(10) Pub. No.: US 2016/0176148 A1
(43) Pub. Date: Jun. 23, 2016

(54) METHOD OF PRODUCING LABEL WITH MOUNT, LABEL WITH MOUNT, AND LABEL MOUNT

(71) Applicant: CASIO COMPUTER CO., LTD., Tokyo (JP)

(72) Inventor: Tomofumi SANO, Iruma-shi (JP)

(73) Assignee: CASIO COMPUTER CO., LTD., Tokyo (JP)

(21) Appl. No.: 15/055,687

(22) Filed: Feb. 29, 2016

Related U.S. Application Data
(63) Continuation of application No. PCT/JP2014/071188, filed on Aug. 11, 2014.

(30) Foreign Application Priority Data
Sep. 24, 2013 (JP) 2013-197087

(51) Int. Cl. B31D 1/02; G09F 3/10; C09J 7/02

(52) U.S. Cl. CPC B31D 1/021; C09J 7/0253; G09F 3/10; C09J 2433/005; C09J 2467/006; C09J 2203/334; C09J 2205/10; G09F 2003/0239

(57) ABSTRACT

A method of producing a label with a mount comprising: forming an adhesive layer on a release sheet; and forming a label base material above the adhesive layer by fixing at a fixing temperature so that the label base material is contact with a coat layer that is formed from a resin having a softening point lower by not less than 10° C. than the fixing temperature of the label base material.

### CROSS-REFERENCE TO RELATED APPLICATIONS

This application is a Continuation Application of PCT Application No. PCT/JP2014/071188, filed Aug. 11, 2014 and based upon and claiming the benefit of priority from Japanese Patent Application No. 2013-197087, filed Sep. 24, 2013, the entire contents of all of which are incorporated herein by reference.

### BACKGROUND OF THE INVENTION

1. Field of the Invention

The present invention relates to a method of producing a label with a mount, a label with a mount produced by the method, and a label mount.

2. Description of the Related Art

A label with a mount is usually produced by the following method. First, a label paper is provided in which an adhesive layer is provided on one side and the adhesive layer is covered with a release paper. Subsequently, a picture is printed on the label paper, and then the label paper is cut into an arbitrary shape.

A label with a mount can also be produced by other methods. First, a release paper having an adhesive layer on one side is provided. Next, a pattern made from toner is formed on the adhesive layer using an electrophotographic method. Then, heat and pressure are applied to the pattern to form a film which enables this pattern to be handled by itself (see, for example, Patent Literature 1). There is also a method in which an ultraviolet-curable resin is used as a binder resin of toner, and the resin is irradiated with ultraviolet rays simultaneously with application of heat and pressure to the above pattern (see, for example, Patent Literature 2). According to those methods, a label can be formed into an arbitrary shape on demand without using a blade.

In these methods using the electrophotographic method, when a label with a mount is produced, a release paper coated with an adhesive is required to be provided. In the release paper coated with an adhesive, if the adhesive is in a state of being exposed to air on the surface, the handling is inconvenient because the adhesive may interfere with transport in a printer, for example. Thus, when a surface of the adhesive is coated with a low viscosity layer (hereinafter referred to as a coat layer), this provides the practical ease of use.

In general, in a label with a mount, when the label is peeled from a release paper and stuck to an object, and then the label is peeled off from the object (this is hereinafter referred to as re-peeling), an adhesive or the like may remain on the object. If the adhesive or the like is finely peeled off together with a label portion without remaining on the object, the ease of use as a label can be enhanced.

### CITATION LIST

### Patent Literatures

[Patent Literature 1] Jpn. Pat. Appln. KOKAI Publication No. 2007-283745

[Patent Literature 2] Jpn. Pat, Appln. KOKAI Publication No. 2010-184470

### BRIEF SUMMARY OF THE INVENTION

In a label with a mount, when a coat layer is provided on an adhesive layer and a label portion is formed on the coat layer, the present inventor encountered the problem that, in the re-peeling, only the label portion is peeled off, and the adhesive layer and the coat layer may remain on an object. Thus, an object of the present invention is to solve this problem. Specifically, an object of the present invention is to provide a method of producing a label with a mount, which can, in the re-peeling, completely peel off a label without remaining the adhesive layer and the coat layer on the object.

According to one aspect of the present invention, there is provided a method of producing a label with a mount, the method comprising: forming an adhesive layer on a release sheet; and forming a label base material above the adhesive layer by fixing at a fixing temperature so that the label base material is contact with a coat layer that is formed from a resin having a softening point lower by not less than 10° C. than the fixing temperature of the label base material.

According to another aspect of the present invention, there is provided a label mount comprising: a release sheet; an adhesive layer provided on the release sheet; and a coat layer containing a coat layer resin having a softening point of not more than 170° C. and provided on the adhesive layer.

According to another aspect of the present invention, there is provided a label with a mount comprising: a release sheet; an adhesive layer provided on the release sheet; a coat layer containing a coat layer resin having a softening point of not more than 170° C. and provided on the adhesive layer; and a label base material made from toner and provided in contact with the coat layer.

The present invention can provide a method of producing a label with a mount, which controls a softening point of a coat layer resin based on a heat fixing temperature of a label base material to enhance binding properties between a coat layer and a label portion and thereby can peel off the label without remaining an adhesive layer and the coat layer on an object in the re-peeling.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a cross-sectional view schematically showing an example of a label with a mount produced by a method according to the present embodiment.

FIG. 2 is a cross-sectional view schematically showing an example of an adhesive label produced by removing a release sheet from the label with the mount shown in FIG. 1.

### DETAILED DESCRIPTION OF THE INVENTION

Hereinafter, an embodiment of the present invention will be described.

The present inventor has found that if a softening point of a coat layer resin is reduced lower than a fixing temperature of a label base material made from toner, binding properties between the coat layer and the label base material are enhanced to solve the above problem in the re-peeling, and the present invention is completed accordingly.

Specifically, the method of producing a label with a mount according to an embodiment of the present invention includes steps of: forming an adhesive layer on a release sheet; and forming a label base material above the adhesive layer by fixing at a fixing temperature so that the label base material is contact with a coat layer that is formed from a resin having a softening point lower by not less than 10° C. than the fixing temperature of the label base material.

The method according to the present embodiment may further include a step of forming a printing layer on the coat layer or on the label base material.

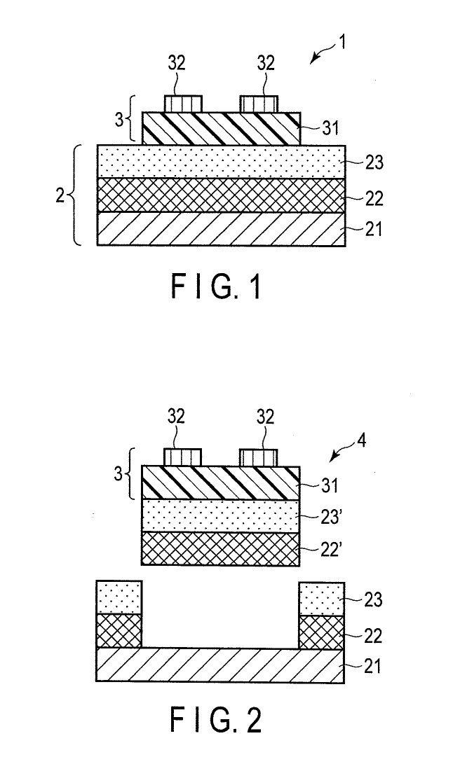

An example of a label with a mount produced by the method according to the present embodiment is shown in FIG. 1.

A label with a mount 1 shown in FIG. 1 includes a label mount 2 and a label layer 3 provided on the label mount 2. The label mount 2 is constituted of a release sheet 21, an adhesive layer 22, and a coat layer 23. The label layer 3 is constituted of a label base material 31 and a printing layer 32.

Hereinafter, the method of the present embodiment will be described with reference to FIG. 1.

In the present embodiment, a softening point of a resin of the coat layer 23 is reduced lower by not less than 10° C. than a fixing temperature of the label base material 31. Consequently, the resin contained in the coat layer 23 is melted when the label base material 31 is heat-fixed to allow enhancement of binding, properties between the coat layer 23 and the label base material 31. As a result, a split is hardly caused between the coat layer 23 and the label base material 31 in the re-peeling to prevent the adhesive layer 22 and the coat layer 23 from remaining on an object. In this specification, the “binding properties between a coat layer and a label base material” means properties in which the coat layer and the label base material are less likely to be separated from each other by melting both a resin of the coat layer and a resin of the label base material by heat to increase connection between them.

Hereinafter, the method of the present embodiment will be described in the order of steps.

In a first step, an adhesive is applied to one principal surface of the release sheet 21 to form the adhesive layer 22.

As the release sheet 21, a release paper, a plastic sheet, or the like may be used. As an adhesive, commonly used adhesives such as an acrylic-based adhesive, a silicone-based adhesive, and a rubber-based adhesive can be used. Parameters such as adhesiveness and tackiness of the adhesive layer 22 can be suitably changed depending on the application purpose of the label. The adhesive layer 22 can be formed by applying an adhesive-containing liquid onto a release sheet and drying it.

In the next step, the coat layer 23 containing a coat layer resin having a softening point lower by not less than 10° C. than the fixing temperature of the label base material 31 is formed on the adhesive layer 22. Consequently, the label mount 2 is formed. The coat layer 23 covers the adhesive layer 22 to facilitate handling of the label mount 2.

The coat layer resin may be the one which has a softening point lower by not less than 10° C., preferably not less than 20° C., and more preferably not less than 30° C. than the fixing temperature of the label base material 31. More specifically, the coat layer resin may be the one which has a softening point lower by 10 to 80° C., preferably 20 to 80° C., and more preferably 30 to 80° C. than the fixing temperature of the label base material 31.

The “fixing temperature of the label base material 31” may be generally 150 to 180° C. and preferably 160 to 180° C.

Accordingly, the “softening point lower by not less than 10° C. than the fixing temperature of the label base material 31” may be generally not more than 170° C., preferably not more than 160° C., more preferably not more than 150° C., and still more preferably not more than 130° C. More specifically, the “softening point lower by not less than 10° C. than the fixing temperature of the label base material 31” may be 100 to 170° C., preferably 100 to 160° C., more preferably 100 to 150° C., and still more preferably 100 to 130° C.

As the coat layer resin, acrylic resin, polyester resin, polyvinyl acetate, polyethylene-vinyl acetate, ionomer resin, polystyrene, ethylene-acrylate resin, and so on may be used. Acrylic resin has an advantage that when an acrylic-based adhesive is used as an adhesive, acrylic resin has good binding properties with the acrylic-based adhesive to provide ease of coating. Acrylic resin is defined as a polymer of acrylic acid having an acrylic skeleton and/or a polymer of acrylic ester. Examples of the acrylic skeleton include acrylic acid, methacrylic acid, crotonic acid, isocrotonic acid, angelic acid, tiglic acid, 2-pentenoic acid, 2-hexenoic acid, methylcrotonic acid, methylisocrotonic acid, and decylenic acid. Examples of an ester group include a functional group such as methyl, ethyl, propyl, isopropyl, butyl, isobutyl, tertiary-butyl, pentyl, isopentyl, neopentyl, cyclopentyl, hexyl, 2-ethylhexyl, vinyl, allyl, cyclohexyl, dodecyl, and dodecenyl.

The coat layer resin may be synthesized by polymerization in accordance with a well-known synthesis method, or a commercially available coat layer resin may be used. When a coat layer resin is prepared by synthesis, a coat layer resin having a desired softening point can be obtained by changing a degree of polymerization with changing reaction conditions. Coat layer resins having various polymerization degrees are prepared in advance under various reaction conditions, and a coat layer resin having a desired softening point is selected from among them, whereby the reaction condition for preparation of the coat layer resin having a desired softening point can be determined.

The coat layer 23 can be formed by applying an emulsion containing a coat layer resin onto the adhesive layer 22 and drying it.

In the subsequent step, a toner layer formed by an electrophotographic method is fixed in contact with the coat layer 23 to form the label base material 31. In addition, if necessary, the printing layer 32 is formed on the label base material 31. Alternatively, the printing layer 32 may be formed between the label base material and the coat layer. Thereby, the label with the mount 1 is formed.

The label base material 31 and the printing layer 32 are each made from toner and formed using an electrophotographic method well-known in the relevant technical field.

The label base material 31 is usually formed partially covering the coat layer 23 (see, FIG. 1). The temperature at which the label base material 31 is fixed may be generally 150 to 180° C. and preferably 160 to 180° C., as described above. The fixing temperature of the printing layer 32 may be the same as the fixing temperature of the label base material 31. The printing layer 32 may be fixed in a different fixing step from the fixing of the label base material 31 or may be fixed simultaneously with the fixing of the label base material 31.

When the label base material 31 is fixed at the above temperature, resin of the coat layer 23 is melted to enhance the binding properties between the coat layer 23 and the label base material 31. Consequently, when the label is stuck to an object, and then the label is peeled off from the object (in the re-peeling), a split is hardly caused between the coat layer 23 and the label base material 31 to prevent the adhesive layer 22 and the coat layer 23 from remaining on the object.

Hereinafter, composition of toner used for formation of the label base material 31 and the printing layer 32 will be described.

Toner used for the formation of the label base material 31 is obtained by mixing, melt-kneading, and grinding a binder resin, a charge control agent, and typically a release agent or the like.

As the binder resin, a thermoplastic resin usually used for a film is used. Examples of the thermoplastic resin include polybutylene succinate-based resin, polyethylene-based resin, polypropylene-based resin, crystalline polyester resin, polyester, polystyrene, acrylic resin, nylon resin, polyimide, urea resin, epoxy resin, melamine resin, polyethylene, polypropylene, cyclic olefin resin, ionomer resin, polyvinyl acetate, polyvinyl alcohol, polyvinyl chloride, polyvinylidene chloride, polycarbonate, polyacrylonitrile, and copolymers thereof. Those resins may be used singly or two or more of them may be used in combination. The softening point of the binder resin may be 80 to 150° C.

The charge control agent is added to adjust charging amount and charging speed of toner. As the charge control agent, arbitrary one used in electrophotographic toner may be usually used.

A release agent is added to prevent an offset phenomenon in which when developed toner is fixed to a releasable sheet by contact heat fixing such as heat roller fixing, a portion of the toner is divided to be stuck to a heated surface. As the release agent, arbitrary one used in electrophotographic toner may be usually used. If no release effect is needed, the release agent may be omitted.

Toner used for the formation of the printing layer 32 is common toner used in printing on paper or the like, for example. In the formation of the printing layer 32, a toner obtained by adding a colorant to the above-described toner for the label base material 31 may be used.

When a surface on the printing layer 32 side of the label layer 3 is a display surface, the label base material 31 may have optical transparency or light shielding properties. When a surface on the opposite side of the printing layer 32 side of the label layer 3 is a display surface, the label base material 31, the coat layer 23, and the adhesive layer 22 are required to have optical transparency.

The printing layer 32 may be interposed between the label base material 31 and the coat layer 23. When such a structure is adopted and the surface on the printing layer 32 side of the label layer 3 is used as a display surface, the coat layer 23 and the adhesive layer 22 are required to have optical transparency. Meanwhile, when such a structure is adopted and the surface on the opposite side of the printing layer 32 side of the label layer 3 is used as a display surface, the label base material 31 is required to have optical transparency.

An adhesive label is produced by removing the release sheet 21 from the label with the mount 1 produced in accordance with the above description. An example of the adhesive label is shown in FIG. 2. In FIG. 2, an adhesive label 4 is produced by peeling the label layer 3 from the release sheet 21 together with a portion 23′ of the coat layer 23 located below the label layer 3 and a portion 22′ of the adhesive layer 22 located below the label layer 3.

### EXAMPLES

Hereinafter, examples of the present invention are shown, and the effect of the present invention will be specifically described.

First, a method of measuring physical property values to be described later is shown.

<1. Method of Measuring Physical Property Values>

(Measurement of Softening Point)

In measurement of a softening point, a flow tester (CFT-500D, manufactured by Shimadzu Corporation) was used.

The weight of a sample was 1 g, a raised temperature was 6° C./min, and load was 20 kg. A nozzle having a diameter of 1 mm and a length of 1 mm was used. A temperature at which half of the sample flowed by a ½ method was defined as a softening point.

For the softening point of emulsion, after the emulsion was satisfactorily dried, only the nonvolatile content of resin was measured.

(Measurement of Toner Particle Diameter)

In measurement of a toner particle diameter, FPIA-2100 (manufactured by Sysmex Corporation) was used. In this measurement, a small amount of toner sample was put into a beaker together with purified water and a surfactant, and the toner particles were dispersed by an ultrasonic cleaning machine. The obtained dispersion liquid was used in the measurement. As the measurement result, a volume average particle diameter (D50) was obtained.

(Measurement of Thickness of Adhesive Layer and Coat Layer)

In measurement of thickness of an adhesive layer and a coat layer, a micrometer (p-mate, manufactured by Sony Corporation) was used.

(Measurement of Binding Properties by Peeling of Label)

In order to measure the binding properties between a coat layer and a label base material, Autograph AGS-J manufactured by Shimadzu Corporation was used. A load cell of 20 N was attached, and a peeling test was carried out by a 90 degree peeling method according to JIS Z0237. A sample having a size of 600 mm×250 mm was used. A label was peeled off from an SUS plate at a rate of 30 mm/sec.

Next, an example of the production of a label is shown.

<2. Example of Production of Label>

(Production of Acrylic Emulsion)

Production of Acrylic Emulsion 1

40 parts by mass of Chemipearl S75N manufactured by Mitsui Chemicals, Inc. was diluted with 56 ml of ion-exchanged water and then heated to 80° C. under a nitrogen. atmosphere, and 0.45 parts by mass of potassium persulfate was added thereto, whereby a mixed solution containing Chemipearl was prepared.

In addition, 0.20 parts by mass of sodium dodecylbenzenesulfonate was added to a mixed solution containing 40 parts by mass of 2-ethylhexyl acrylate, 10 parts by mass of glycidyl methacrylate, and 20 ml of ion-exchanged water to prepare an emulsion mixture.

The emulsion mixture was dropped into the mixed solution containing Chemipearl over three hours. After that, the resulting mixture was reacted for four hours to obtain an acrylic emulsion 1 having a nonvolatile content of 44%. The softening point of the obtained acrylic emulsion 1 was 181° C.

Production of Acrylic Emulsions 2 to 6

Acrylic emulsions 2 to 6 having the following softening points were produced by the same method as the production of the acrylic emulsion 1 except that the amount of added potassium persulfate was gradually increased within the range of 0.45 to 7.0 parts by mass, and the dropping time of the emulsion mixture was gradually reduced within the range of 0.3 to 3 hours.

| | | |
|---|---|---|
| Acrylic emulsion 2 | Nonvolatile content of 42% | Softening point |
| | | of 170° C. |
| Acrylic emulsion 3 | Nonvolatile content of 39% | Softening point |
| | | of 158° C. |
| Acrylic emulsion 4 | Nonvolatile content of 40% | Softening point |
| | | of 150° C. |
| Acrylic emulsion 5 | Nonvolatile content of 42% | Softening point |
| | | of 141° C. |
| Acrylic emulsion 6 | Nonvolatile content of 40% | Softening point |
| | | of 134° C. |

(Production of Label Mount)

Production of Label Mount 1

100 parts by mass of an adhesive SK Dyne 1811L from Soken Chemical & Engineering Co., Ltd. which is an acrylic-based adhesive and 0.2 parts by mass of a curing agent TD-75 manufactured by Soken Chemical & Engineering Co., Ltd. were mixed and then stirred at room temperature for two hours. The resulting mixture was applied onto a separator using an applicator, then aged at 100° C. for two minutes, and further aged at room temperature for one week to obtain a mount.

The acrylic emulsion 1 was diluted with ion-exchanged water so that the nonvolatile content was 15%. The diluted acrylic emulsion 1 was applied onto a surface of the adhesive of the above mount, and then dried at room temperature for one night to obtain the label mount 1

Production of Label Mounts 2 to 6

Label mounts 2 to 6 were produced by the same method as the production of the label mount 1 except that the acrylic emulsions 2 to 6 were used.

Production of Label Mount 7

After the production of the label mount 1, the acrylic emulsion 6 was further applied onto the label mount 1 to produce a label mount 7.

(Synthesis of Polybutylene Succinic Acid)

5 parts by mass of an 88% lactic acid aqueous solution containing 0.4 parts by mass of malic acid and 1 part by mass of germanium dioxide was added to 100 parts by mass of succinic acid and 89 parts by mass of 1,4-butanediol. After the reaction system was made under a nitrogen atmosphere, reaction was carried out at 220° C. for one hour, and then the pressure was reduced to 70 Pa over 1.5 hours while temperature was increased to 230° C. Further, polymerization was allowed to proceed for two hours to obtain polybutylene succinic acid.

(Production of Toner as Label Base Material)

96.5 parts by mass of the obtained polybutylene succinic acid, 1 part by mass of LR-147 from Japan Carlit Co., Ltd. which is a charge control agent, and 25 parts by mass of carnauba wax (manufactured by S. Kato & Co.) were mixed and then kneaded by a twin screw kneading extruder. The kneaded material was ground under liquid nitrogen by Linrex mill manufactured by Hosokawa Micron Group to obtain powder particles having D50 (volume average particle diameter) of 37 μm.

After that, 100 parts by mass of the obtained powder particles were stirred together with hydrophobized silica particles (0.2 parts by mass of RY200 manufactured by Japan Aerosil and 0.7 parts by mass of NY50 manufactured by Japan Aerosil) by a Henschel mixer to coat the powder particles with the silica particles, thereby obtaining toner which becomes a label base material (D50 (volume average particle diameter): 37 μm, softening point: 125° C.)

(Production of Label with Mount)

### Example 1

### Example 1A

The obtained toner was developed on the label mount 1 of an A4 size by an electrophotographic process, and the label mount 1 having the developed toner on the surface was passed through a fixing device at 180° C. at 17 mm/sec., whereby a label base material having a thickness of 80 μm was obtained on the label mount.

After that, an image was developed on the label base material by an N5300 printer manufactured by Casio Computer Co., Ltd. and fixed at 180° C. to produce a label with a mount 1A.

### Examples 1B to 1F

Labels with mounts 1B to 1F were produced by the same method as the Example 1A except that the temperature of heat rollers of the fixing device was changed to 170° C., 160° C., 150° C., 140° C., and 130° C.

When toner was fixed at a temperature of not more than 140° C., the toner itself was not satisfactorily melted, and thus a label could not be formed.

### Examples 2 to 7

Labels with mounts 2A to 2F were produced using a label mount 2, while changing the setting temperature of the fixing device as in the Example 1.

Similarly, labels with mounts 3A to 3F, 4A to 4F, 5A to 5F, 6A to 6F, and 7A to 7F were produced using label mounts 3 to 7, respectively.

Hereinafter, the evaluation results of the produced labels with mounts are shown.

<3. Evaluation Results>

(Evaluation Method)

The produced labels were stuck onto an SUS plate, and then the label was peeled off from the SUS plate. After that, the binding properties between a label base material and a coat layer were evaluated from the remaining amounts of an adhesive and a coat layer on the SUS plate.

(Evaluation Criteria)
∘: The coat layer and the adhesive did not remain on the SUS plate.
Δ: The coat layer and the adhesive remained on the SUS plate in an area of less than 10% of a label area.
×: The coat layer and the adhesive remained on the SUS plate in an area of not less than 10% of the label area.
—: Toner was not melted.

(Results)

The evaluation results are shown in the following Table 1.

TABLE 1

| | | | Binding properties between label base material | | | | | |
|---|---|---|---|---|---|---|---|---|
| | | | and coat layer | | | | | |
| | | Softening | Setting temperature of fixing device | | | | | |
| | Label | point of coat | A | B | C | D | E | F |
| | mount | layer resin | 180° C. | 170° C. | 160° C. | 150° C. | 140° C. | 130° C. |
| Example 1 | 1 | 181° C. | x | x | x | x | — | — |
| Example 2 | 2 | 170° C. | Δ | x | x | x | — | — |
| Example 3 | 3 | 158° C. | ∘ | Δ | x | x | — | — |
| Example 4 | 4 | 150° C. | ∘ | ∘ | Δ | x | — | — |
| Example 5 | 5 | 141° C. | ∘ | ∘ | ∘ | Δ | — | — |
| Example 6 | 6 | 134° C. | ∘ | ∘ | ∘ | ∘ | — | — |
| Example 7 | 7 | 181° C./134° C. | ∘ | ∘ | ∘ | ∘ | — | — |

Example 1 shows the results of the labels with mounts 1A to 1F which were produced by fixing a label base material at the fixing temperatures of 180° C., 170° C., 160° C., 150° C., 140° C., and 130° C. onto the label mount 1 containing a coat layer resin having a softening point of 181° C. In the Example 1, since the softening point of the used coat layer resin was 181° C., no matter what fixing temperature was employed, the coat resin layer was not melted. Thus, the binding properties between the coat layer and the label base material were low, and the adhesive and the coat layer remained on the SUS plate when the label was peeled off.

Example 2 shows the results of the labels with mounts 2A to 2F which were produced by fixing a label base material at the fixing temperatures of 180° C., 170° C., 160° C., 150° C., 140° C., and 130° C. onto the label mount 2 containing a coat layer resin having a softening point of 170° C. In the Example 2, since the softening point of the used coat layer resin was 170° C., only when the fixing temperature of 180° C. was employed, the coat layer resin was melted, and the binding properties between the coat layer and the label base material were enhanced.

Example 3 shows the results of the labels with mounts 3A to 3F which were produced by fixing a label base material at the fixing temperatures of 180° C., 170° C., 160° C., 150° C., 140° C., and 130° C. onto the label mount 3 containing a coat layer resin having a softening point of 158° C. In the Example 3, since the softening point of the used coat layer resin was 158° C., when the fixing temperature of 170° C. was employed, the coat layer resin was melted, and the binding properties between the coat layer and the label base material were enhanced. When the fixing temperature of 180° C. was employed, the binding properties between the coat layer and the label base material were further enhanced.

Example 4 shows the results of the labels with mounts 4A to 4F which were produced by fixing a label base material at the fixing temperatures of 180° C., 170° C., 160° C., 150° C., 140° C., and 130° C. onto the label mount 4 containing a coat layer resin having a softening point of 150° C. In the Example 4, since the softening point of the used coat layer resin was 150° C., when the fixing temperature of 160° C. was employed, the coat layer resin was melted, and the binding properties between the coat layer and the label base material were enhanced. When the fixing temperatures of 170° C. and 180° C. were employed, the binding properties between the coat layer and the label base material were further enhanced.

Example 5 shows the results of the labels the mounts 5A to 5F which were produced by fixing a label base material at the fixing temperatures of 180° C., 170° C., 160° C., 150° C., 140° C., and 130° C. onto the label mount 5 containing a coat layer resin having a softening point of 141° C. In the Example 5, since the softening point of the used coat layer resin was 141° C., when the fixing temperature of 150° C. was employed, the coat layer resin was melted, and the binding properties between the coat layer and the label base material were enhanced. When the fixing temperatures of 160° C., 170° C., and 180° C. were employed, the binding properties between the coat layer and the label base material were further enhanced.

Example 6 shows the results of the labels with mounts 6A to 6F which were produced by fixing a label base material at the fixing temperatures of 180° C., 170° C., 160° C., 150° C., 140° C., and 130° C. onto the label mount 6 containing a coat layer resin having a softening point of 134° C. In the Example 6, since the softening point of the used coat layer resin was 134° C., when the fixing temperature of 140° C. was employed, the coat layer resin was melted, and the binding properties between the coat layer and the label base material were enhanced. When the fixing temperatures of 150° C., 160° C., 170° C., and 180° C. were employed, the binding properties between the coat layer and the label base material were further enhanced.

In Example 7, a first coat layer containing a coat layer resin having a softening point of 181° C. was formed, and a second coat layer containing a coat layer resin having a softening point of 134° C. was formed thereon, whereby the two coat layers were provided. Example 7 shows the results of the labels with mounts 7A to 7F which were produced by fixing a label base material at the fixing temperatures of 170° C., 160° C., 150° C., 140° C., and 130° C. onto the label mount 7 having the above two coat layers. In the Example 7, when the fixing temperature of 140° C. was employed, the coat layer resin positioned on a surface in contact with the label base material was melted, and the binding properties between the coat layer and the label base material were enhanced. When the fixing temperatures of 150° C., 160° C., 170° C., and 180° C. were employed, the binding properties between the coat layer and the label base material were further enhanced.

These results show that the binding properties between the coat layer and the label base material can be enhanced if a coat layer resin having a softening point lower by not less than 10° C. than a setting temperature of a fixing device is used in an outermost surface of a label mount. These results further show that the binding properties between the coat layer and the label base material can be further enhanced if a coat layer resin having a softening point lower by not less than 20° C. than the setting temperature of the fixing device is used in the outermost surface of the label mount. Furthermore, if a coat layer resin having a softening point lower by not less than 30° C. than the setting temperature of the fixing device is used in the outermost surface of the label mount, the binding properties between the coat layer and the label base material could be further reliably enhanced.

As shown in the Example 7, if the coat layer has a two-layer structure, there is an advantage that a label can have satisfactory stiffness. Further, if the coat layer has the two-layer structure, the respective coat layers can have different functions.

This application claims priority based on Japanese Patent Application No. 2013-197087, filed on Sep. 24, 2013, the entire disclosure of which is incorporated by reference herein.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

### REFERENCE SIGNS LIST

1 . . . label with mount

2 . . . label mount

3 . . . label layer

4 . . . adhesive label

21 . . . release sheet

22 . . . adhesive layer

23 . . . coat layer

31 . . . label base material

32 . . . printing layer

What is claimed is:

1. A method of producing a label with a mount comprising:
forming an adhesive layer on a release sheet; and
forming a label base material above the adhesive layer by fixing at a fixing temperature so that the label base material is contact with a coat layer that is formed from a resin having a softening point lower by not less than 10° C. than the fixing temperature of the label base material,
wherein the label base material contains a binder resin having a softening point lower than the softening point of a resin forming the coat layer.

2. The method of producing a label with a mount according to claim 1, further comprising forming a printing layer on the label base material or between the label base material and the coat layer.

3. The method of producing a label with a mount according to claim 1, wherein the resin forming the coat layer has a softening point lower by not less than 30° C. than the fixing temperature of the label base material.

4. The method of producing a label with a mount according to claim 1, wherein the resin forming the coat layer is an acrylic resin.

5. The method of producing a label with a mount according to claim 1, wherein the fixing temperature at which the label base material is fixed is 150 to 180° C.

6. The method of producing a label with a mount according to claim 2, wherein the resin forming the coat layer has a softening point lower by not less than 30° C. than the fixing temperature of the label base material.

7. The method of producing a label with a mount according to claim 2, wherein the fixing temperature at which the label base material is fixed is 150 to 180° C.

8. A label mount comprising:
a release sheet;
an adhesive layer provided on the release sheet; and
a coat layer containing a coat layer resin having a softening point of not more than 170° C. and provided on the adhesive layer;
wherein the softening point of the coat layer resin is higher than the softening point of a binder resin contained in a label base material to be provided on the coat layer.

9. A label with a mount comprising:
a release sheet;
an adhesive layer provided on the release sheet;
a coat layer containing a coat layer resin having a softening point of not more than 170° C. and provided on the adhesive layer; and
a label base material made from toner and provided in contact with the coat layer, wherein the label base material contains a binder resin having a softening point lower than the softening point of the coat layer resin.
